(19) United States
(12) Patent Application Publication
(10) Pub. No.: US 2025/0019851 A1
(43) Pub. Date: Jan. 16, 2025

(54) ELECTROCHEMICAL EXTRACTION FROM CEMENTED CARBIDE

(71) Applicant: Kennametal India Ltd., Bangalore (IN)

(72) Inventor: Prabin Achuthankutty, Palakkad Dist. (IN)

(21) Appl. No.: 18/767,035

(22) Filed: Jul. 9, 2024

(30) Foreign Application Priority Data
Jul. 10, 2023 (IN) 202341046400

(51) Int. Cl. C25C 1/08; C25C 7/02; C25C 7/06; C25D 3/12

(52) U.S. Cl. CPC C25C 1/08; C25C 7/02; C25C 7/06; C25D 3/12

(57) ABSTRACT

Electrochemical methods of extracting metals from cemented carbide using non-aqueous solvents are disclosed. A substrate comprising cemented carbide serves as an anode. The substrate and a cathode are immersed in an electrolyte comprising a non-aqueous solvent and a current is applied, extracting metal from the cemented carbide. The extracted metal is then retrieved.

### RELATED APPLICATION DATA

The present application claims priority pursuant to 35 U.S.C. 119(a) to Indian Patent Application No. 202341046400 filed Jul. 10, 2023, which is incorporated herein by reference in its entirety.

### FIELD OF THE INVENTION

The present invention relates to metal extraction from cemented carbide, and more particularly relates to electrochemical metal extraction.

### BACKGROUND OF THE INVENTION

Metal based cermets or cemented carbides have high wear resistance, high hardness, high melting points, and excellent corrosion resistance. As a result, they are used for a wide range of applications, including machine tool manufacturing, military ammunitions, and aerospace, among others. Widespread use of metal based cermets or cemented carbides results in a large amount of alloy scraps. Different processes of recycling the metals contained in the cermets and cemented carbides have been developed, including hydrometallurgy and powder metallurgy. However, these processes are not environmentally friendly and are not cost effective. It would be desirable to have a method of extraction that achieves high quality outputs while having less environmental impact and being more energy efficient.

### SUMMARY OF THE INVENTION

The present invention provides electrochemical methods of extracting metal from cemented carbide substrates using non-aqueous solvents. The methods comprise immersing a substrate comprising cemented carbide comprising a metal carbide and the metal into an electrolyte comprising a non-aqueous solvent, wherein the substrate serves as an anode; immersing a cathode into the electrolyte; applying an electrical current between the substrate and the cathode whereby the metal is extracted from the substrate; and recovering the extracted metal.

### BRIEF DESCRIPTION OF THE DRAWINGS

FIG. 1 schematically illustrates an extraction method.

FIG. 2 shows samples of the prepared electrodes.

FIG. 3 schematically illustrates a system for performing an extraction method.

FIG. 4A shows the concentration of Co extracted as a function of temperature during electro-dissolution carried out at 4 V.

FIG. 4B shows the concentration of Ni extracted as a function of temperature during electro-dissolution carried out at 4 V.

FIG. 4C shows the concentration of W extracted as a function of temperature during electro-dissolution carried out at 4 V.

FIG. 4D shows the concentration of Fe extracted as a function of temperature during electro-dissolution carried out at 4 V.

FIG. 5A shows the concentration of Co extracted as a function of voltage during electro-dissolution carried out at 60° C.

FIG. 5B shows the concentration of Ni extracted as a function of voltage during electro-dissolution carried out at 60° C.

FIG. 5C shows the concentration of W extracted as a function of voltage during electro-dissolution carried out at 60° C.

FIG. 5D shows the concentration of Fe extracted as a function of voltage during electro-dissolution carried out at 60° C.

FIG. 6A shows an SEM image of the surface of a bare stainless-steel electrode.

FIG. 6B shows an SEM image of the surface of a stainless-steel electrode of Example 4 following exposure to an electrical current of 4 V at 80° C.

FIG. 6C shows an SEM image of the surface of a stainless-steel electrode of Example 4 following exposure to an electrical current at 4 V at 25° C.

FIG. 6D shows an SEM image of the surface of a stainless-steel electrode of Example 4 following exposure to an electrical current of 2 V at 60° C.

FIG. 6E shows an SEM image of the surface of a stainless-steel electrode of Example 4 following exposure to an electrical current of 4 V at 40° C.

FIG. 6F shows an SEM image of the surface of a stainless-steel electrode of Example 4 following exposure to an electrical current of 6 V at 60° C.

FIG. 6G shows an SEM image of the surface of a stainless-steel electrode of Example 4 following exposure to an electrical current of 4 V at 60° C.

FIG. 6H shows an image of the surface of a stainless-steel electrode of Example 4 following exposure to an electrical current of 8 V at 60° C.

FIG. 7 shows an X-Ray Diffractogram for deposited electrodes at various temperatures.

FIG. 8 shows an X-Ray Diffractogram for deposited electrodes at various voltages.

FIG. 9A shows optical surface measurements for an SS electrode following deposition.

FIG. 9B shows optical surface measurements for an SS/AC electrode following deposition.

FIG. 9C shows optical surface measurements for an SS/AC/PANI electrode following deposition.

FIG. 10A shows an SEM image of an SS electrode prior to deposition.

FIG. 10B shows an SEM image of an SS electrode following deposition.

FIG. 10C shows an SEM image of an SS/AC electrode prior to deposition.

FIG. 10D shows an SEM image of an SS/AC electrode following deposition.

FIG. 10E shows an SEM image of an SS/AC/PANI electrode prior to deposition.

FIG. 10F shows an SEM image of an SS/AC/PANI electrode following deposition.

FIG. 11A is a graph of the extraction rate of Co as a function of time during electro-dissolution at 4 V and 25° C. using an SS electrode, an SS/AC electrode, and an SS/AC/PANI electrode.

FIG. 11B is a graph of the extraction rate of Ni as a function of time during electro-dissolution at 4 V and 25° C. using an SS electrode, an SS/AC electrode, and an SS/AC/PANI electrode.

FIG. 11C is a graph of the extraction rate of W as a function of time during electro-dissolution at 4 V and 25° C. using an SS electrode, an SS/AC electrode, and an SS/AC/PANI electrode.

FIG. 11D is a graph of the extraction rate of Fe as a function of time during electro-dissolution at 4 V and 25° C. using an SS electrode, an SS/AC electrode, and an SS/AC/PANI electrode.

FIG. 12 shows an XRD analysis of the surface of an SS deposited electrode, an SS/AC deposited electrode, and an SS/AC/PANI deposited electrode.

### DETAILED DESCRIPTION

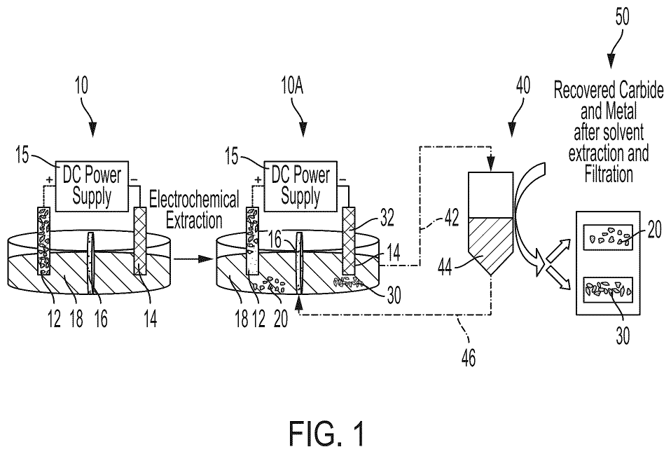

FIG. 1 schematically illustrates a system for performing electrochemical extraction of metals and/or carbides. The system includes an electrochemical cell 10 including an anode 12 comprising a pre-prepared cemented carbide scrap substrate comprising metal carbide and binder metal and a cathode 14 immersed a bath of an electrolyte 18 comprising an ionic solvent. The anode 12 and cathode 14 are connected to a regulated DC power supply 15. The electrolyte 18 is divided by a porous membrane or separator 16.

As further shown in FIG. 1, during the electrochemical process, the electrolytic cell 10A is operated by providing an electrical current from the DC power supply 15 to the submerged anode 12 and the submerged cathode 14 through the electrolyte 18. Upon application of the electrical current, metal carbide 20 and binder metal 30 contained in the anode 12 are electrochemically loaded into the electrolyte 18. The metal carbide 20 is insoluble in the electrolyte 18 and precipitates out of the electrolyte 18. The binder metal, which is soluble in the electrolyte 18, crosses the porous membrane separator 16, where a portion thereof may deposit 32 onto the surface of the cathode 14. In addition to such deposition 32, some or all of the metal may solubilize into the electrolyte in the form of solubilized metal 30. During operation, the electrolyte may be stirred and heated to control the temperature of the electrolyte 18.

The ionic solvent of the electrolyte 18 is then transported 42 to a solvent extraction system, where the ionic solvent is mixed with a second solvent, such as octane-1-ol, for solvent extraction of the binder metal. The metal carbide 20 is extracted from the ionic solvent through filtration, then washed and dried for reuse. The ionic solvent is then recycled back into the electrolyte 18 following extraction of the metals.

The system shown in FIG. 1 may be provided as a closed loop system. As used herein, “closed loop system” refers to a system in which the electrolytic cell and the solvent extraction process are fluidly connected, such as through a system of pipes, thus allowing for the system to operate continuously without a separate step of retrieving the electrolyte and the metal in order to use in solvent extraction.

The substrate comprising cemented carbide serves as an anode 12 during the electrochemical extraction method disclosed herein. The anode 12 and the cathode 14 are immersed in an electrolyte 18 comprising a non-aqueous solvent. As used herein, the term “non-aqueous solvent” means a solvent that is substantially free of water, e.g., means water is not present, or is present in only a minimal amount as an impurity rather than being purposefully added to the solvent. The non-aqueous solvent may comprise, consist essentially of, or consist of an ionic solvent. As used herein, “ionic solvent” refers to a solvent comprising an anionic component and a cationic component. The ionic solvent may comprise a eutectic solvent. As used herein, “eutectic solvent” refers to solvents comprising a first compound comprising a hydrogen bond acceptor and a second compound comprising a hydrogen bond donor, wherein the melting point of the eutectic solvent is lower than the melting point of the first compound alone and the melting point of the second compound alone. The eutectic solvent may comprise a deep eutectic solvent. As used herein, “deep eutectic solvent” or “DES” refers to eutectic solvents that exhibit a melting point that is significantly less than the first and second compounds, for example at least 100° C. less, or at least 200° C. less, or at least 300° C. less, or at least 400° C. less.

Any suitable hydrogen bond acceptor known in the art may be used. Examples of suitable hydrogen bond acceptors include but are not limited to compounds comprising phosphonium cations and/or ammonium cations, including quaternary ammonium cations and/or non-quaternary ammonium cations. Suitable compounds comprising a quaternary ammonium cation include, for example, choline chloride ([(CH₃)₃NCH₂CH₂OH]⁺Cl⁻), tetra-n-butylammonium bromide, tetra-n-ethyl ammonium chloride, and tetramethylammonium chloride. Suitable compounds comprising a non-quaternary ammonium cation include, for example, 2-(chlorocarbonyloxy)-N,N,N-trimethylethaminium chloride, N-benzyl-2-hydroxy-N,N-dimethylethaminium, N,N-diethylethanolammonium chloride, and N-ethyl-2-hydroxy-N,N-dimethylethaminium chloride. Suitable compounds comprising phosphonium cations include, for example, benzyltriphenylphosphonium chloride and methyltriphenylphosphonium bromide. Other suitable hydrogen bond acceptors include but are not limited to lidocaine; amino acids including alanine, glycine, proline, and histidine; nicotinic acid; choline fluoride; and betaine.

Any suitable hydrogen bond donor known in the art may be used. The hydrogen bond donor may comprise, for example, glycerol (C₃H₈O₃), ethylene glycol, urea, adipic acid, acetamide, phenol, benzamide, benzoic acid, thymol, malonic acid, thiourea, succinic acid, 1,3-dimethyl urea, oxalic acid, lactic acid, citric acid, 1-methyl urea, 1-naphthol, glucose, 1,1-dimethyl urea, 1,4-butanediol, decanoic acid, fructose, tricthylene glycol, dodecanoic acid, methanol, or combinations thereof.

The hydrogen bond acceptor and hydrogen bond donor may be present in a molar ratio of at least 1:4, such as at least 3:7. The hydrogen bond acceptor and hydrogen bond donor may be present in a molar ratio of no more than 2:3, such as no more than 1:2. The hydrogen bond acceptor and hydrogen bond donor may be present in a molar ratio of from 1:4 to 2:3, such as from 3:7 to 1:2. In examples, the hydrogen bond acceptor and hydrogen bond donor may be present in a molar ratio of 1:2.

Suitable substrates that may be used in the present invention are any substrates comprising cemented carbide. The substrate may comprise hard scraps and/or soft scraps of cemented carbide. As used herein, the term “hard scraps” refers to an end product prepared from cemented carbide. As used herein, the term “soft scraps” refers to sludge, chips, and/or other waste that is formed in the process of forming products comprising cemented carbide. It has been surprisingly discovered that the method disclosed herein may be used to extract metals from soft scraps. However, any cemented carbide substrate may be used in the method disclosed herein. The extraction method disclosed herein is beneficial over conventional means, such as acid leeching, which can chemically modify the extracted metals.

The cemented carbide may comprise, consist essentially of, or consist of a metal carbide and a metallic binder.

The metal carbide may comprise Group IVB metal carbides, Group VB metal carbides, Group VIB metal carbides, or combinations thereof. For example, the metal carbide may comprise tungsten carbide, chromium carbide, titanium carbide, vanadium carbide, tantalum carbide, niobium carbide, zirconium carbide, and/or hafnium carbide. For example, the metal carbide may comprise tungsten carbide.

The metallic binder or metal of the cemented carbide may comprise cobalt, cobalt alloys, nickel, nickel alloys, iron, iron alloys, or combinations thereof. In some embodiments, the metallic binder may comprise cobalt and/or cobalt alloys. The metallic binder may comprise one or more additives, such as noble metal additives. Examples of noble metal additives that may be used in the cemented carbide include but are not limited to platinum, palladium, rhenium, rhodium, and ruthenium, and alloys thereof. Other additives include molybdenum, silicon, or combinations thereof.

A cathode is also immersed in the electrolyte. The cathode may comprise any conductive material known in the art, such as conductive metals and alloys thereof. Suitable conductive materials include but are not limited to titanium, aluminum, iron, copper, and alloys thereof. The metal or metal alloy can comprise or be steel, such as stainless steel, cold rolled steel, hot rolled steel, electrogalvanized steel, and/or hot dipped galvanized steel. The cathode may comprise a coating comprising activated carbon on at least a portion of the surface of the cathode. It was surprisingly discovered that a cathode comprising stainless steel coated with activated carbon significantly improved extraction efficiency of metals from cemented carbide substrates when compared to a bare stainless steel cathode.

The electric current and the temperature at which the method of electrochemical extraction is conducted may be adjusted in order to achieve the desired effect. Higher voltage and temperature result in more efficient extraction of metals from the cemented carbide. Lower voltage and temperature result in more uniform deposition and metal selective deposition onto the surface of the cathode.

During the electrochemical extraction, an electric current is applied to the anode and cathode. The electric current may be at least 1 V, such as at least 2 V, such as at least 3 V, such as at least 4 V. The electric current may be no more than 10 V, such as no more than 8 V, such as no more than 7 V, such as no more than 6 V. The electric current may be from 1 V to 10 V, such as from 2 V to 8 V, such as from 3 V to 7 V, such as from 4 V to 6 V.

During the electrochemical extraction, the electrolyte may be heated to a temperature of at least 20° C., such as at least 25° C., such as at least 30° C., such as at least 40° C. The electrolyte may be heated to a temperature of no more than 100° C., such as no more than 90° C., such as no more than 80° C., such as no more than 60° C. The electrolyte may be heated to a temperature of from 20° C. to 100° C., such as from 25° C. to 90° C., such as 30° C. to 80° C., such as 40° C. to 60° C.

When the electric current is applied to the anode and cathode, at least one metal is extracted from the substrate comprising the cemented carbide. The extracted metal may be soluble, such as nickel, cobalt, iron, or combinations thereof. The metal carbide is separated from the substrate and is insoluble in the ionic solvent.

The extracted metals may be deposited onto a portion of a surface of the cathode. For example, cobalt may be deposited onto the cathode. The soluble metals may be deposited onto the surface of the cathode in elemental form.

Following application of the electric current, the extracted metals are retrieved from the non-aqueous solvent. The metals may be extracted by any methods known in the art. For example, insoluble metals may be retrieved through filtration. In other examples, soluble metals may be retrieved by a standard solvent extraction method.

The following examples are intended to illustrate various aspects of the present invention and are not intended to limit the scope of the invention.

### EXAMPLES

### Example 1: Preparation of Cemented Carbide Soft Scrap

Samples of cemented carbide soft scrap were prepared by drying in an oven at 110° C. for 2 hours to remove any moisture contamination. The elemental composition of the soft scrap samples was analyzed using an Olympus Vanta C series XRF and results are provided in Table 1. The soft scrap samples were weighed and bagged using cotton cloth.

TABLE 1
Cemented carbide lathe swarf elemental composition

| | Elemental composition |
|---|---|
| Element | in Wt. % |
| W | 71.187 |
| Co | 10.433 |
| Ni | 9.192 |
| C | 4.544 |
| Fe | 2.149 |
| Cr | 1.464 |
| Cu | 0.480 |
| Al | 0.432 |
| O | 0.061 |
| Mo | 0.052 |
| Nb | 0.004 |
| Zr | 0.003 |

### Example 2: Preparation of Electrolyte

A deep eutectic solvent (DES) was prepared with Choline chloride (ChCl) and glycerol (analytical grade) in a molar ratio ChCl:glycerol of 1:2. The ChCl and glycerol were combined in a vacuum/nitrogen atmosphere at 80° C. The solution was stirred continuously until a consistent clear liquid was obtained. This was further dried at 110° C. under vacuum for 24 hours before usage to remove any moisture.

### Example 3: Preparation of Electrode

Three panels of S316 grade stainless steel (SS) with a thickness of 0.25 mm were cut into 1 cm×1 cm dimensions. The surfaces of the samples were polished using various grade emery sheets by standard polishing procedures, applying force unidirectionally. Once polished, the surfaces were rinsed with distilled water and acetone.

An electrode slurry was prepared by mixing 50 mg of activated carbon (Enasco 350G, Imerys Graphite and Carbon) and 1% of polyvinylidene fluoride (PVDF) (Sigma-Aldrich) in N-methyl-2-pyrrolidone to produce a homogenous slurry.

Two of the SS panels were coated on the surface with the electrode slurry in a thickness of 0.04 mm using the manual doctor blade method. The activated carbon-coated stainless steel panels (SS/AC) were dried in an oven at 50° C. for 12 hours.

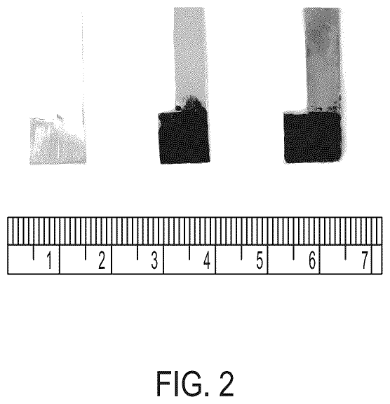

One of the SS/AC panels was used for the electrochemical polymerization of aniline in 0.1 N sulphuric acid, 0.1 M sodium dodecyl sulfate (SDS), and 0.1 M aniline to form a new SS/AC/PANI panel. Electropolymerization of aniline in Polyaniline (PANI) on the samples was done by cyclic voltammetry (CV) in a potential window of 0.2 V to 0.8 V with a 10 mV/s using a Gamry reference 600+potentiostat/galvanostat controlled by framework software using a three-electrode system. Saturated calomel electrode (SEC) was used as a reference and platinum electrode was used as the counter electrode for 20 CV cycles to obtain PANI grafting on the sample electrode. Images of sample electrodes are provided in FIG. 2. The left electrode comprises SS, the middle electrode comprises SS/AC, and the right electrode comprises SS/AC/PANI.

The SS electrode panel, the SS/AC electrode panel, and the SS/AC/PANI electrode panel were compared for extraction efficiency and followed by metal deposition and characterization.

### Example 4: Electrochemical Experiments

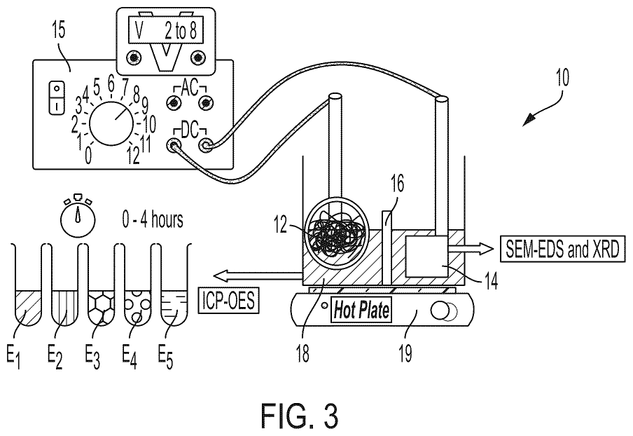

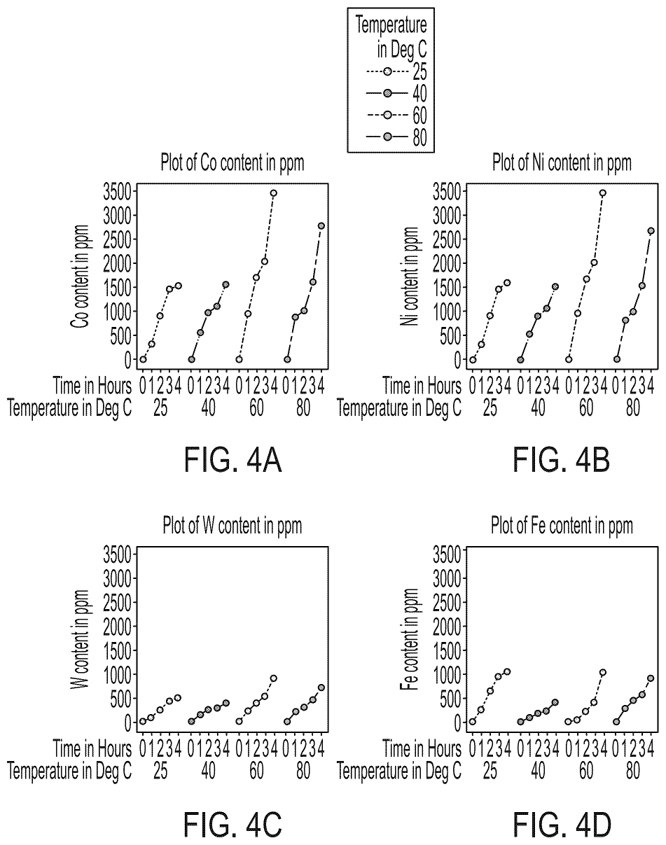

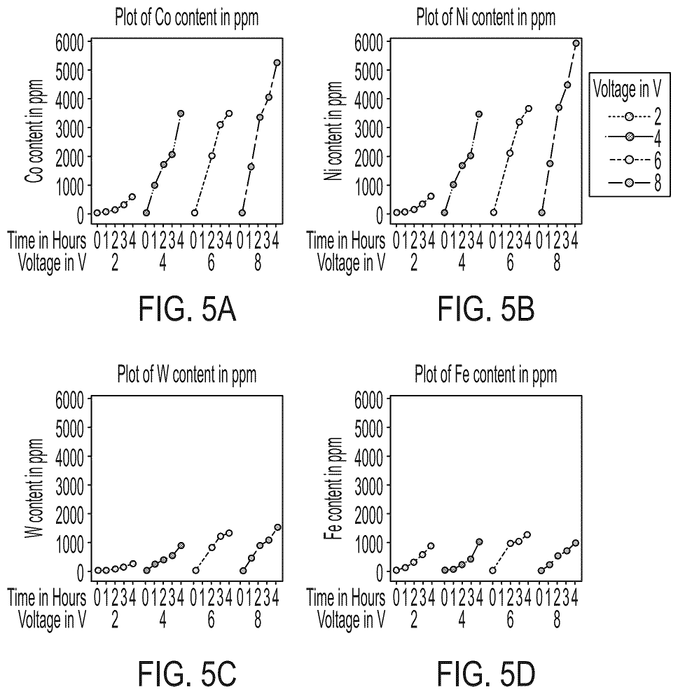

As schematically shown in FIG. 3, the anode comprising the soft scrap sample 12 and the cathode comprising stainless steel 14 were immersed in the DES electrolyte 18 for 4 hours as shown in FIG. 3. A porous membrane separator 16 was placed in the electrolyte between the anode 12 and the cathode 14. Aplan L3205 regulated DC power supply equipment 15 was used to supply an electric current to the system. The electrolyte was heated by a heating mechanism 19. The voltage and temperature were varied across experimental conditions. The results are provided in Table 2. Electrolyte samples (E₁, E₂, E₃, E₄, and E₅) were collected every hour over the course of four hours and analyzed for the presence of cobalt, tungsten, nickel, and iron using Perkin Elmer optima 8000 Inductively coupled plasma-optical emission spectrometer (ICP-OES). As shown in FIGS. 4A-4D, the loading of Co, Ni, W, and Fe in the electrolyte was higher when the electro-dissolution was carried out at approximately 60° C. As shown in FIGS. 5A-5D, the loading of Co, Ni, W, and Fe in the electrolyte was higher when the electro-dissolution process was carried out at approximately 8 V.

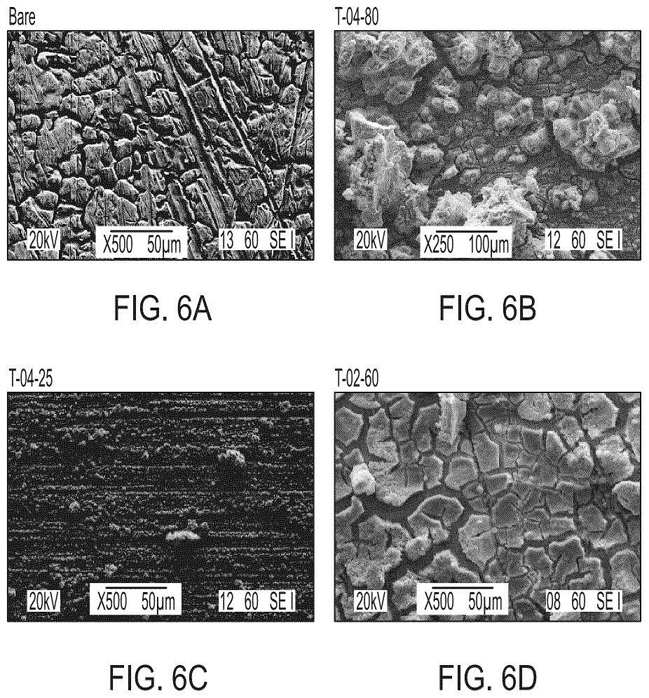

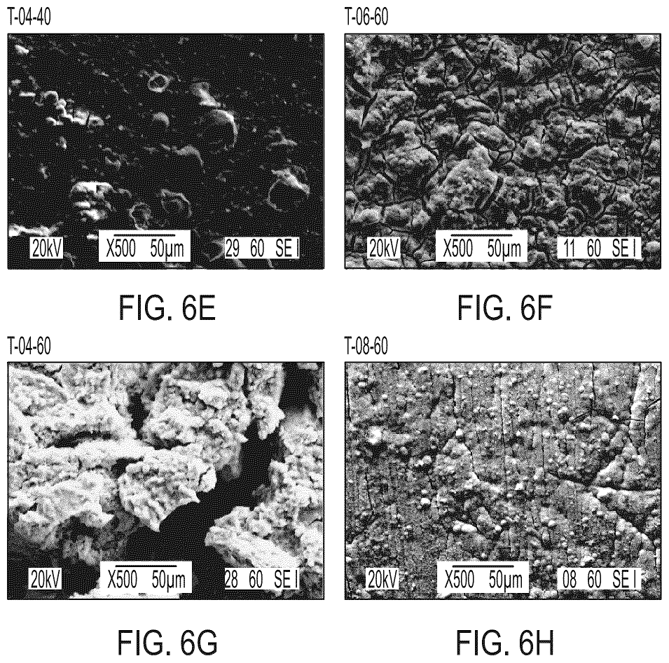

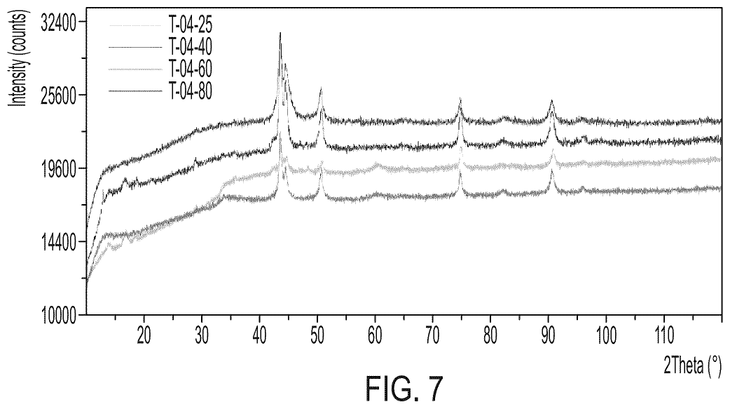

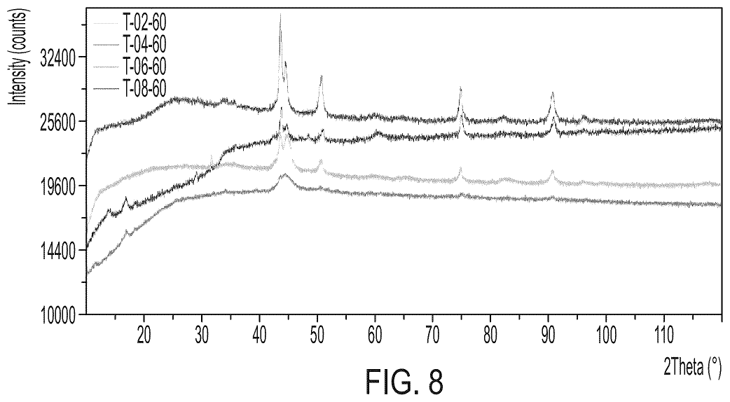

The stainless steel electrodes were also analyzed using scanning electron microscopy-energy dispersive X-ray spectroscopy (SEM-EDS) and X-ray diffraction (XRD). SEM images of the electrode surface at various temperatures and voltages are provided in FIGS. 6A-6H. As shown, changes in temperature and voltage at which electro-dissolution occurs results in differences in deposition thickness, uniformity, and flake sizes. As the temperature increased from room temperature (25° C.) to 80° C., the deposition increased, but decreased in uniformity of deposit sizes. As the voltage increased from 2 V to 8 V, the flakiness of the deposits decreased, and the uniformity of the deposit sizes increased. X-Ray Diffractograms of deposited electrodes for various temperatures and voltages are provided in FIGS. 7 and 8, respectively. As the temperature increased from 25° C. to 80° C. at a constant voltage of 4 V, the deposition increased. As the voltage increased from 2 V to 8 V at a constant temperature of 60° C., the deposition also increased.

### Example 5: Modified Electrode Characterization

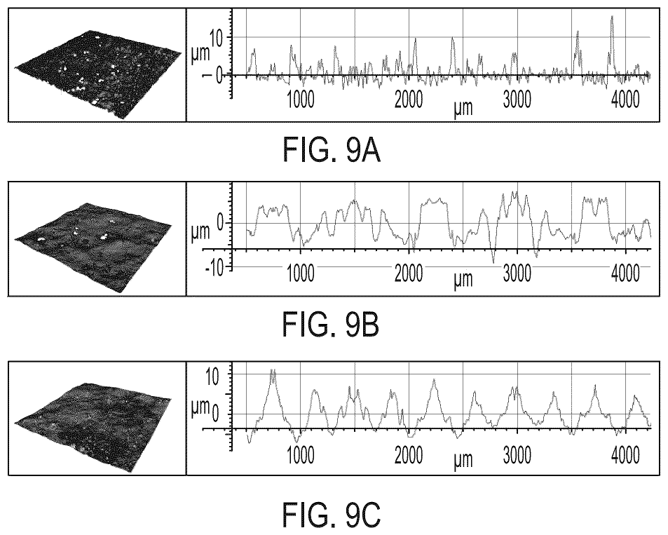

The surface morphology and roughness of the deposits on the modified electrodes were mapped using Bruker alicona G5 model optical surface measuring system to visualize the nature and consistency of the deposition, as shown in FIGS. 9A-9C. Electrodes comprising SS and SS/AC/PANI exhibit uniform surface roughness of the electrodes after deposition, indicating uniform deposition. Electrodes comprising SS/AC exhibit surface roughness variations, indicating non-uniform surface depositions.

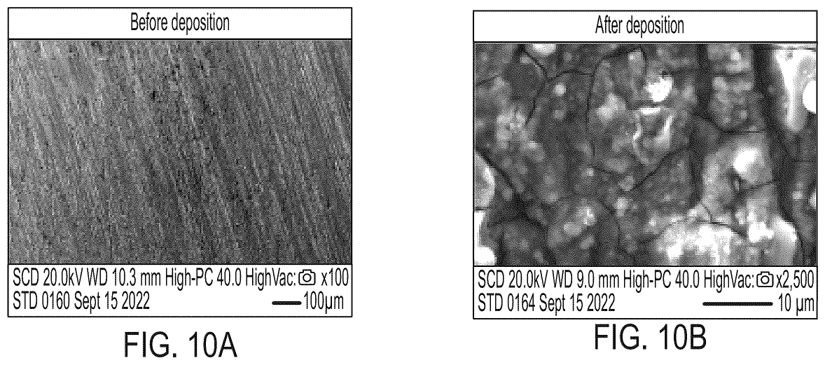

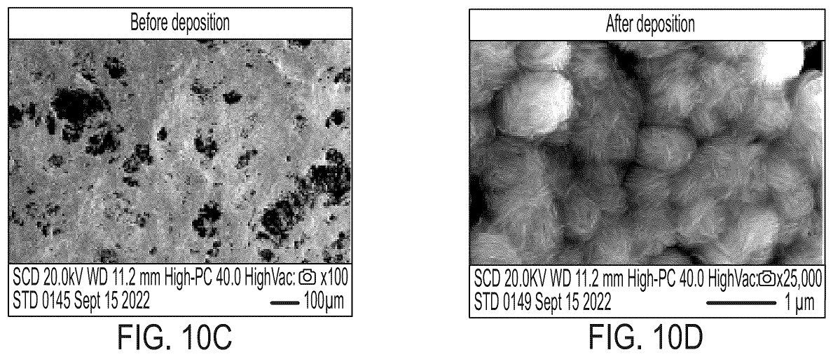

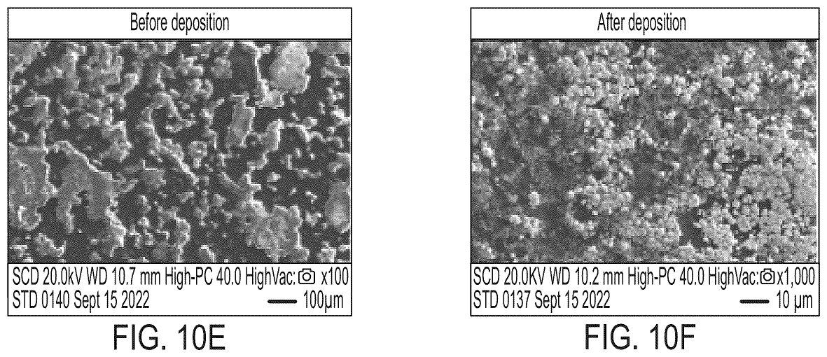

SEM analysis, conducted as previously disclosed herein, was also conducted on the modified electrodes. The SEM images of the electrodes before and after deposition are provided in FIGS. 10A-10F. The deposition on the SS electrode was found to be a uniform rough surface layer with fine micro cracks. The deposition on the SS/AC electrode was found to be globular and fluffy with a uniform diameter of less than 1 microns. The surface morphology of the deposits were found to be uniformly covering the activated carbon surface with good adhesion due to the fluffy surface of the globule. The deposition on the SS/AC/PANI electrode was found to be granular in nature with multiple welded granules to form clusters of deposits with diameters from 0.5 microns to less than 10 microns. The deposits are uniform throughout the surface with good adhesion due to the weld like structure.

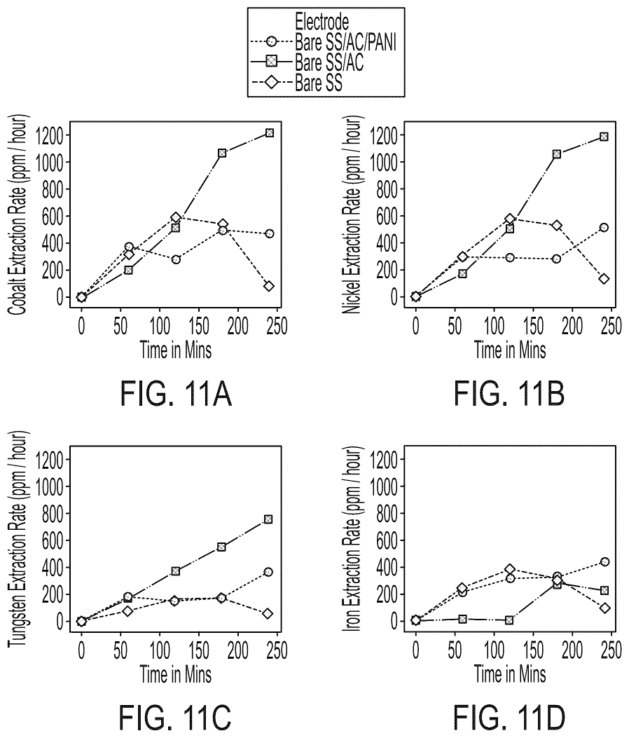

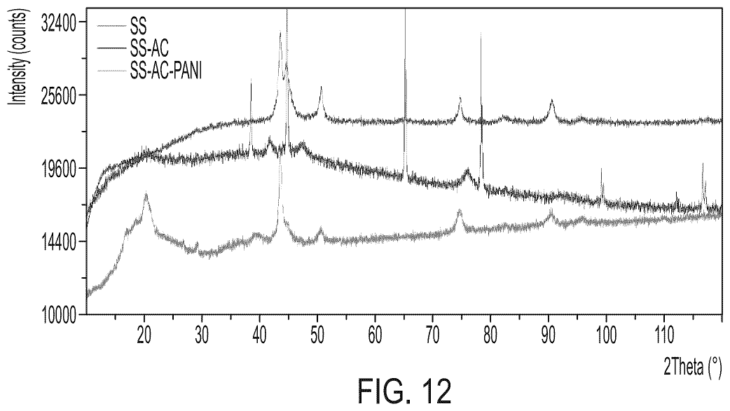

FIGS. 11A-11D provides extraction rates of various modified electrodes at 4 V and 25 C. for Co, Ni, W, and Fe. As shown, the extraction rates of cobalt, nickel, and tungsten were significantly higher with an SS/AC electrode relative to SS and SS/AC/PANI electrodes. The extraction rate of iron was significantly higher with an SS/AC electrode than an SS electrode. FIG. 12 provides XRD analysis for modified electrodes. As shown, the SS/AC deposited electrode had sharper peaks, indicating the high crystallinity of these deposits of cobalt onto the surface of the electrode. It was surprisingly discovered that the modified electrode helps to change the surface morphology and deposition rates due to an increased surface area of the electrode.

TABLE 2
Electro-dissolution experimental details

| | Experiment | Voltage | Electrolyte |
|---|---|---|---|
| Sl No. | Name | in V | temperature in ° C. |
| 1 | T-04-25 | 4 | 25 |
| 2 | T-04-40 | 4 | 40 |
| 3 | T-04-60 | 4 | 60 |
| 4 | T-04-80 | 4 | 80 |
| 5 | T-02-60 | 2 | 60 |
| 6 | T-06-60 | 6 | 60 |
| 7 | T-08-60 | 8 | 60 |

For purposes of this detailed description, it is to be understood that the invention may assume various alternatives and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters set forth the broad scope of the invention are approximations, the numerical values set forth in the specific examples are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “from 1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing,” and like terms are understood in the context of this application to be synonymous with “comprising” and are therefore open-ended and do not exclude the presence of additional undescribed or unrecited elements, materials, ingredients, or method steps. As used herein, “consisting of” is understood in the context of this application to exclude the presence of any unspecified element, ingredient, or method step. As used herein, “consisting essentially of” is understood in the context of this application to include the specified elements, materials, ingredients, or method steps “and those that do not materially affect the basic and novel characteristic(s)” of what is being described.

In this application, the use of the singular includes the plural and plural encompasses singular, unless specifically stated otherwise. For example, although reference is made herein to “a” substrate, “a” non-aqueous solvent, and “an” electrolyte, a combination (i.e., a plurality) of these components may be used.

In addition, in this application, the use of “or” means “and/or” unless specifically stated otherwise, even though “and/or” may be explicitly used in certain instances.

Whereas specific aspects of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A method of electrochemical extraction of a metal from cemented carbide comprising:
immersing a substrate comprising cemented carbide comprising a metal carbide and a metal into an electrolyte comprising a non-aqueous solvent, wherein the substrate serves as an anode;
immersing a cathode into the electrolyte;
applying an electrical current between the substrate and the cathode whereby the metal is extracted from the substrate; and
recovering the extracted metal.

2. The method of claim 1, wherein the metal is soluble in the electrolyte and is recovered by solvent extraction.

3. The method of claim 1, wherein the metal is deposited onto the cathode.

4. The method of claim 1, wherein the metal comprises cobalt, nickel, iron, combinations thereof, or alloys thereof.

5. The method of claim 1, wherein the metal comprises cobalt.

6. The method of claim 1, wherein the metal carbide is removed from the substrate.

7. The method of claim 1, wherein the metal carbide is insoluble in the electrolyte.

8. The method of claim 1, further comprising recovering the metal carbide.

9. The method of claim 8, wherein the metal carbide comprises tungsten carbide, chromium carbide, titanium carbide, vanadium carbide, tantalum carbide, niobium carbide, zirconium carbide, or combinations thereof.

10. The method of claim 8, wherein the metal carbide comprises tungsten carbide.

11. The method of claim 8, wherein the recovering of the metal carbide comprises filtering the electrolyte.

12. The method of claim 1, wherein the non-aqueous solvent comprises an ionic solvent.

13. The method of claim 12, wherein the ionic solvent comprises a first compound comprising a hydrogen bond acceptor and a second compound comprising a hydrogen bond donor.

14. The method of claim 9, wherein the ionic solvent comprises a eutectic solvent, wherein the eutectic solvent exhibits a melting point that is lower than the melting point of the first compound alone and the melting point of the second compound alone.

15. The method of claim 14, wherein the eutectic solvent comprises a deep eutectic solvent, wherein the deep eutectic solvent exhibits a melting point that is at least 100° C. less than the melting point of the first compound alone and the melting point of the second compound alone.

16. The method of claim 13, wherein the hydrogen bond acceptor comprises choline chloride and the hydrogen bond donor comprises glycol.

17. The method of claim 16, wherein the hydrogen bond acceptor and the hydrogen bond donor are present in a molar ratio of at least 1:4.

18. The method of claim 1, wherein the cathode comprises stainless steel.

19. The method of claim 1, wherein the cathode comprises a coating comprising activated carbon on at least a portion of a surface of the cathode.

20. The method of claim 1, wherein the electrical current is from 1 V to 10 V.

21. The method of claim 1, wherein the electrolyte is maintained at a temperature of from 20° C. to 100° C.

22. The method of claim 1, wherein the electrolyte is provided in a bath, at least a portion of the electrolyte and the metal are removed from the bath, and at least a portion of the electrolyte is recirculated to the bath after the metal is extracted from the electrolyte.

23. The method of claim 1, wherein the method is performed in a closed loop system.

24. The method of claim 22, further comprising recovering the metal carbide from the electrolyte.
